(19) United States
(12) Patent Application Publication
(10) Pub. No.: US 2026/0212276 A1
(43) Pub. Date: Jul. 23, 2026

(54) GRAZING-INCIDENCE SMALL-ANGLE SCATTERING DATA FITTING METHOD AND SYSTEM

(71) Applicant: Shanghai Jiao Tong University, Shanghai (CN)

(72) Inventors: Shengyi ZHONG, Shanghai (CN); Ruobing BAI, Shanghai (CN); Jinghan LI, Shanghai (CN); Hao LIN, Shanghai (CN); Xiaoqing SHANG, Shanghai (CN)

(73) Assignee: Shanghai Jiao Tong University, Shanghai (CN)

(21) Appl. No.: 19/461,665

(22) Filed: Jan. 27, 2026

(30) Foreign Application Priority Data
Feb. 27, 2025 (CN) 202510220841.1

(51) Int. Cl. G06N 20/00

(52) U.S. Cl. CPC G06N 20/00

(57) ABSTRACT

Disclosed are a grazing-incidence small-angle scattering data fitting method and system. The method includes: constructing a grazing-incidence small-angle scattering model to obtain an objective function; pre-processing experimental data and inputting the experimental data into the objective function; determining a nanoparticle by using a Porod fitting method according to the experimental data after pre-processing; confirming the objective function according to a determination result, performing Monte Carlo fitting, and outputting a best parameter; iteratively optimizing the best parameter by using a gradient descent method, and outputting a fitting parameter result; and performing post-processing on the fitting parameter result, outputting a visualization fitting result, and performing evaluation. The present disclosure solves a problem of characterization deviation where a traditional data processing process relies on human operation, a result is significantly affected by human subjectivity and model selection, and stability is poor, by introducing a multi-stage optimization process; and significantly improves processing efficiency of GISAS experimental data and quantitative characterization capability of a microstructure, capable of meeting efficient processing needs of multiple sets of experimental data, and providing more reliable technical support for subsequent material research.

### FIELD

The present disclosure belongs to the field of data processing, and specifically relates to a grazing-incidence small-angle scattering data fitting method and system.

### BACKGROUND

In an application in a multi-phase dense flow system, one phase is typically dispersed in a substrate phase at a very low volume fraction, such as proteins distributed in water or metal precipitates present in a substrate of an alloy. Grazing-incidence small-angle scattering technology can extract partial structure parameters of a target phase, including morphology, size distribution, surface roughness, and volume fraction of particles. Since scattering signals between particles in the multi-phase dense flow system do not interfere with each other, a total scattering signal can be regarded as a simple superposition of scattering contributions of individual particles.

Currently, existing grazing-incidence small-angle scattering fitting methods rely on selected specific models to describe arrangement characteristics of nano-objects. However, if model selection is inaccurate, even if experimental data and fitting results seem to match, obtained structure parameters may have serious deviations. In addition, existing data analysis and fitting processes usually require researchers to manually adjust models and parameters, which have strong subjectivity, making the existing data analysis and fitting processes difficult to effectively meet processing needs of complex large-scale data.

Research results proposed in the document “Application of GISAXS in the Investigation of Three-Dimensional Lattices of Nanostructures” (Crystals 9.9 (2019): 479.) published by Lovro Basioli et al. in the journal “Crystals” in 2019 demonstrate an application of GISAS technology in nanostructure analysis, and develop GisaxsStudio software, which can be used to simulate and fit GISAXS data. However, the method still needs to select corresponding models for different materials to describe the arrangement characteristics of the nano-objects. Moreover, the research has not realized automation of data fitting, and fitting efficiency and result stability are limited by experience of researchers.

Patent document “Method and System for Automatically Fitting Small-Angle Scattering Data” (CN111159847A) discloses realizing automated fitting of small-angle scattering data by combining a heuristic algorithm, a gradient descent method, and a grid search method, thereby significantly reducing influence caused by human subjectivity in a data processing process. However, coarse tuning thereof is too simple, robustness is poor, and adaptability is not high, leading to easy loss of microstructure characterization information.

Therefore, an automated fitting method based on GISAS data is urgently needed, where the automated fitting method does not rely on additional model selection, realizes automatic search and fitting of model parameters, and avoids errors caused by manual adjustment.

### SUMMARY

In view of the defects in the prior art, the present disclosure aims to provide a grazing-incidence small-angle scattering data fitting method and system.

Provided according to the present disclosure is a grazing-incidence small-angle scattering data fitting method, including: Step S1: constructing a grazing-incidence small-angle scattering model to obtain an objective function; Step S2: pre-processing experimental data and inputting the experimental data into the objective function; Step S3: determining whether nanoparticles/small-scale structures exist by using a Porod fitting method according to the experimental data after pre-processing; Step S4: confirming the objective function according to a determination result, performing Monte Carlo fitting, and outputting a best parameter; Step S5: iteratively optimizing the best parameter by using a gradient descent method, and outputting a fitting parameter result; and Step S6: performing post-processing on the fitting parameter result, outputting a visualization fitting result, and performing evaluation.

In some embodiments, Step S1 includes: Step S1.1: selecting a buried model or a supported model according to a geometric structure of an actual sample to be measured; and setting a distribution density function of a spherical particle model

$${N}_{log} ( K , m , ϵ ) = \frac{1}{K ϵ \sqrt{2 π}} {e}^{- \frac{{( 1 n ( K - m ) )}^{2}}{2 {ϵ}^{2}}}$$

and a scattering intensity of a spherical particle grazing-incidence small-angle scattering model

$${I}_{all - sphere} ( R , σ , q , {k}_{i} , {k}_{f} , {a}_{i} , {a}_{f} , {θ}_{f} , {f}_{v} ) = {Σ}_{{θ}_{f} = {θ}_{0}}^{{θ}_{f} = {θ}_{max}} {Σ}_{{a}_{f} = {0}^{∘}}^{{a}_{f} = {a}_{f}} {Σ}_{R = R - σ}^{R = R + σ} \\ {I}_{single - sphere} ( R , σ , q , {k}_{i} , {k}_{f} , {a}_{i} , {a}_{f} , {θ}_{f} , {f}_{v} )$$

collectively as the objective function; and constructing a fitting function and setting parameters to be fitted (m, ϵ) and (R, σ, fᵥ);
where
m represents a mean of a radius of the spherical particle;
ϵ represents a mean variance of the radius of the spherical particle;
R represents a single spherical particle radius;
σ represents a mean variance of the single spherical particle radius;
fᵥ represents a spherical particle volume fraction coefficient;
K represents a structure parameter;
θ_{f} represents an in-plane exit angle;
θ₀ represents a minimum in-plane exit angle;
θₘₐₓ represents a maximum in-plane exit angle;
I_{single-sphere}( ) represents a grazing-incidence small-angle scattering illumination intensity of the single spherical particle radius;
kᵢ represents an incident wave vector;
k_{f} represents an exit wave vector;
aᵢ represents an incident angle;
a_{f} represents an exit angle; and
q represents a small-angle scattering vector.
Step S1.2: inputting a parameter range to be fitted qₘᵢₙ, qₘₐₓ according to an objective law to construct a parameter space for parameter search.

In some embodiments, Step S2 includes:
Step S2.1: performing normalization on the experimental data; and
Step S2.2: setting an upper limit and a lower limit of the parameter space according to the parameter range to be fitted and a resolution that is set.

In some embodiments, Step S3 includes:
Step S3.1: calculating a small-angle scattering intensity I_{porod}, where

$${I}_{porod} , {I}_{porod} {q}^{4} = {C}_{p} + {I}_{Laue} {q}^{4} ;$$

where C_p represents a Porod constant; and
I_{Laue} represents a Laue scattering intensity.

Step S3.2: plotting a curve with q⁴ as a horizontal axis and I_{porod} q⁴ as a vertical axis, determining a relationship of a scattering curve in a range of qR<<1, if the scattering curve presents a significant linear relationship, indicating that I_{Laue} is a constant at this time, determining that no nanoparticle exists, and ending the fitting; and if the scattering curve does not present a significant linear relationship, determining that the nanoparticle exists, and continuing to execute Step S4.

In some embodiments, Step S4 includes:
Initial parameter setting step: setting a parameter range Θₘᵢₙ<Θₖ<Θₘₐₓ in the parameter space of the objective function through empirical data or prior knowledge;
where Θₖ represents a combined parameter; and
Θₘᵢₙ and Θₘₐₓ represent a minimum value and a maximum value of the combined parameter, respectively.

Random sampling step: inputting a parameter set Θₖ generated by random distribution into the objective function to obtain a model scattering intensity I_{all-sphere-Monte} (Θₖ).

Loss function calculation step: setting a chi-square value of an initial optimal parameter

$${X}_{r}^{2} ( {Θ}_{hest} ) > 5 ,$$

calculating a corresponding loss function chi-square value

$${X}_{r}^{2} ( {Θ}_{k} ) = {\frac{1}{N - n} [ \frac{{I}_{exp} ( {q}_{1} ) - {I}_{all - sphere - Monte} ( {Θ}_{k} )}{Δ I ( {q}_{1} )} ]}^{2}$$

according to the parameter set Θₖ, and judging

$${X}_{r}^{2} ( {θ}_{k} ) , if {X}_{r}^{2} ( {Θ}_{k} ) < {X}_{r}^{2} ( {Θ}_{best} ) ,$$

setting Θ_{best}=Θₖ, and if

$${X}_{r}^{2} ( {Θ}_{k} ) \geq {X}_{r}^{2} ( {Θ}_{best} ) ,$$

executing the random sampling step;
where N represents a number of grazing-incidence small-angle scattering experimental points;
n represents a number of fitting parameters;
qᵢ represents an i-th small-angle scattering vector;
Iₑₓₚ represents a scattering intensity of grazing-incidence small-angle scattering in an experiment;
ΔI(·) represents a small-angle scattering intensity error in the experiment; and
I_{all-sphere-Monte}(·) represents the model scattering intensity.

Fitting termination step: judging

$${X}_{r}^{2} ( {Θ}_{best} )$$

and a number of samplings, if

$${X}_{r}^{2} ( {Θ}_{best} ) < 5$$

or a set upper limit of the number of samplings is reached, executing the result output step; and if

$${X}_{r}^{2} ( {Θ}_{best} ) \geq 5$$

and the set upper limit is not reached, executing the random sampling step and the loss function calculation step to continue the fitting.

Result output step: outputting an optimal parameter Θ_{best}, and setting a starting point Θ₁=Θ_{best} to be passed into a gradient descent optimization algorithm.

In some embodiments, Step S5 includes: Initialization parameter step: setting an initial learning rate η and a maximum number of iterations Tₘₐₓ according to the starting point Θ₁ obtained by the optimal parameter Θ_{best}, where Θ₁=Θ_{best} and η>0, calculating an initial loss function

$${ℒ}^{( 0 )} = {X}_{r}^{2} ( {Θ}_{1} ) ,$$

and recording an initial gradient as ∇_{Θ} [symbol] (Θ₁).

Calculating gradient step: calculating a gradient of a loss function with respect to parameters ∇_{Θ} [symbol] (Θ^{(t)}) for the loss function [symbol] (Θ^{(t)}) under a parameter Θ^{(t)}, where

$${∇}_{Θ} ℒ ( {Θ}^{( t )} ) = - \frac{2}{N - n} {\sum }_{i = 1}^{N} \frac{{I}_{exp} ( {q}_{1} ) - {I}_{all - sphere - Monte} ( {Θ}^{( t )} )}{Δ I ( {q}_{1} )} \cdot \frac{\partial {I}_{all - sphere - Monte} ( {Θ}^{( t )} )}{\partial {Θ}^{( t )}} ;$$

where N represents the number of grazing-incidence small-angle scattering experimental points;
n represents the number of fitting parameters;
qᵢ represents the i-th small-angle scattering vector;
Iₑₓₚ represents the scattering intensity of grazing-incidence small-angle scattering in the experiment;
ΔI(·) represents the small-angle scattering intensity error in the experiment;
I_{all-sphere-Monte}(·) represents the model scattering intensity;
and Θ^{(t)} represents a parameter value of a t-th iteration, and Θ₁=Θ⁽⁰⁾.

Parameter update step: updating Θ^{(t)} to Θ^{(t+1)}, where Θ^{(t+1)}=Θ^{(t)}-η∇_{Θ} [symbol] (Θ^{(t)}).

Termination check and result output step: re-calculating a loss function [symbol] ^{(t+1)} of a (t+1)-th iteration and comparing the loss function [symbol] ^{(t+1)} with a loss function [symbol] ^{t} of the t-th iteration, if | [symbol] ^{(t+1)}- [symbol] ^{(t)}|<0.01 or the maximum number of iterations Tₘₐₓ is reached, terminating the iteration and executing the verifying fitting quality step; and if | [symbol] ^{(t+1)}- [symbol] ^{(t)}|≥0.01 and the maximum number of iterations Tₘₐₓ is not reached, executing the calculating gradient step and the parameter update step to continue the iteration.

Verifying fitting quality step: outputting a fitting parameter result Θ*, where Θ*=Θ^{(t)}, setting a gradient descent optimal solution θ₂=Θ*, judging whether

$${X}_{r}^{2} ( {θ}_{2} ) < 1 ,$$

determining that a fitting quality is qualified and retaining θ*, and if

$${X}_{r}^{2} ( {θ}_{2} ) \geq 1 ,$$

determining that the fitting quality is not qualified and discarding Θ*.

In some embodiments, Step S6 includes:
Step S6.1: performing statistical processing on the fitting parameter result, outputting a final fitting result θₒᵤₜ±Δθₒᵤₜ, and comparing and evaluating a physical meaning of the fitting parameter and a reasonableness thereof under experimental conditions in combination with other characterization methods;
and Step S6.2: outputting as a one-dimensional table and a two-dimensional table according to a match between fitting data obtained from the final fitting result and the experimental data to obtain the visualization fitting result.

According to a grazing-incidence small-angle scattering data fitting system provided in the present disclosure, the system includes:
Module M1 configured to construct a grazing-incidence small-angle scattering model, and obtain an objective function;
Module M2 configured to pre-process experimental data and input the experimental data into the objective function;
Module M3 configured to determine a nanoparticle using a Porod fitting method according to the pre-processed experimental data;
Module M4 configured to confirm the objective function according to a determination result, perform Monte Carlo fitting, and output an optimal parameter;
Module M5 configured to iteratively optimize the optimal parameter using a gradient descent method, and output a fitting parameter result; and
Module M6 configured to perform post-processing on the fitting parameter result, and output and evaluate a visualization fitting result.

In some embodiments, Module M1 includes:
Module M1.1 configured to select a buried model or a supported model according to a geometric structure of an actual sample to be measured, and set a distribution density function of a spherical particle model

$${N}_{log} ( K , m , ϵ ) = \frac{1}{K ϵ \sqrt{2 π}} {e}^{- \frac{{( ln ( k - m ) )}^{2}}{2 {ϵ}^{2}}}$$

and a scattering intensity of a spherical particle grazing-incidence small-angle scattering model

$${I}_{all - sphere} ( R , σ , q , {k}_{i} , {k}_{f} , {a}_{i} , {a}_{f} , {θ}_{f} , {f}_{v} ) = {\sum }_{{θ}_{f} = {θ}_{0}}^{{θ}_{f} - {θ}_{max}} {\sum }_{{a}_{f} = 0 °}^{{a}_{f} = {a}_{f}} {\sum }_{R = R - σ}^{R = R + σ} {I}_{single - sphere} ( R , σ , q , {k}_{i} , {k}_{f} , {a}_{i} , {a}_{f} , {θ}_{f} , {f}_{v} )$$

together as the objective function; and constructing a fitting function and setting parameters to be fitted (m, ϵ) and (R, σ, fᵥ);
where
m represents a mean of a radius of the spherical particle;
ϵ represents a mean variance of the radius of the spherical particle;
R represents a single spherical particle radius;
σ represents a mean variance of the single spherical particle radius;
fᵥ represents a spherical particle volume fraction coefficient;
K represents a structure parameter;
θ_{f} represents an in-plane exit angle;
θ₀ represents a minimum in-plane exit angle;
θₘₐₓ represents a maximum in-plane exit angle;
I_{single-sphere}( ) represents a grazing-incidence small-angle scattering illumination intensity of the single spherical particle radius;
kᵢ represents an incident wave vector;
k_{f} represents an exit wave vector;
aᵢ represents an incident angle;
a_{f} represents an exit angle; and
q represents a small-angle scattering vector.

Module M1.2 configured to input a parameter range qₘᵢₙ and qₘₐₓ of the parameters to be fitted according to an objective law to construct a parameter space for parameter search.

In some embodiments, Module M2 includes:
Module M2.1 configured to perform normalization processing on the experimental data;
And Module M2.2 configured to set an upper limit and a lower limit of the parameter space according to the parameter range of the parameters to be fitted and a set resolution.

In some embodiments, Module M3 includes:
Module M3.1 configured to calculate a small-angle scattering intensity I_{porod}, where I_{porod} q⁴=Cₚ+I_{Laue} q⁴,
where Cₚ represents a Porod constant; and I_{Laue} represents a Laue scattering intensity.

Module M3.2 configured to plot a curve with q⁴ as a horizontal axis and I_{porod} q⁴ as a vertical axis, determine a relationship of a scattering curve in a range of qR<<1, if the scattering curve presents a significant linear relationship, indicate that I_{Laue} is a constant at this time, determine that no nanoparticle exists, and end the fitting; and if the scattering curve does not present a significant linear relationship, determine that the nanoparticle exists, and continue to trigger Module M4.

In some embodiments, Module M4 includes:
Initial parameter setting module configured to set a parameter range Θₘᵢₙ≤Θₖ≤Θₘₐₓ in the parameter space of the objective function through empirical data or prior knowledge;
where Θₖ represents a combined parameter; and Θₘᵢₙ and Θₘₐₓ represent a minimum value and a maximum value of the combined parameter, respectively.

Random sampling module configured to input a parameter set Θₖ generated by random distribution into the objective function to obtain a model scattering intensity

$${I}_{all - sphere - Monte} ( {Θ}_{k} ) .$$

Loss function calculation module configured to set a chi-square value of an initial optimal parameter

$${X}_{r}^{2} ( {Θ}_{best} ) > 5 ,$$

calculate a corresponding loss function chi-square value

$${X}_{r}^{2} ( {Θ}_{k} ) = {\frac{1}{N - n} [ \frac{{I}_{exp} ( {q}_{i} ) - {I}_{all - sphere - Monte} ( {Θ}_{k} )}{Δ I ( {q}_{i} )} ]}^{2}$$

according to the parameter set Θₖ, and judge

$${X}_{r}^{2} ( {Θ}_{k} ) , if {X}_{r}^{2} ( {Θ}_{k} ) < {X}_{r}^{2} ( {Θ}_{best} ) , set {X}_{r}^{2} ( {Θ}_{k} ) < {X}_{r}^{2} ( {Θ}_{best} ) ,$$

and if

$${X}_{r}^{2} ( {Θ}_{k} ) \geq {X}_{r}^{2} ( {Θ}_{best} ) ,$$

trigger the random sampling module;
where
N represents a number of grazing-incidence small-angle scattering experimental points;
n represents a number of fitting parameters;
qᵢ represents an i-th small-angle scattering vector;
Iₑₓₚ represents a scattering intensity of grazing-incidence small-angle scattering in an experiment;
ΔI(·) represents a small-angle scattering intensity error in the experiment;
and I_{all-sphere-Monte}(·) represents the model scattering intensity

Fitting termination module configured to judge

$${X}_{r}^{2} ( {Θ}_{best} )$$

and a number of samplings, if

$${X}_{r}^{2} ( {Θ}_{best} ) < 5$$

or a set upper limit of the number of samplings is reached, trigger the result output module; and if

$${X}_{r}^{2} ( {Θ}_{best} ) \geq 5$$

and the set upper limit is not reached, trigger the random sampling module and the loss function calculation module to continue the fitting.

Result output module configured to output an optimal parameter Θ_{best}, and set a starting point Θ₁=Θ_{best} to be passed into a gradient descent optimization algorithm.

In some embodiments, Module M5 includes:

Initialization parameter module configured to set an initial learning rate η and a maximum number of iterations Tₘₐₓ according to the starting point Θ₁ obtained by the optimal parameter Θ_{best}, where Θ₁=Θ_{best} and η>0, calculate an initial loss function

$${ℒ}^{( 0 )} = {X}_{r}^{2} ( {Θ}_{1} ) ,$$

and record an initial gradient as ∇_{Θ} [symbol] (Θ₁).

Calculation gradient module configured to calculate a gradient of a loss function with respect to parameters ∇_{Θ} [symbol] (Θ^{(t)}) for the loss function [symbol] (Θ^{(t)}) under a parameter Θ^{(t)}, where

$${∇}_{Θ} ℒ ( {Θ}^{( t )} ) = - \frac{2}{N - n} {\sum }_{i = 1}^{N} \frac{{I}_{exp} ( {q}_{i} ) - {I}_{all - sphere - Monte} ( {Θ}^{( t )} )}{Δ I ( {q}_{i} )} \cdot \frac{\partial {I}_{all - sphere - Monte} ( {Θ}^{( t )} )}{\partial Θ ( t )} ;$$

where
N represents a number of grazing-incidence small-angle scattering experimental points;
n represents a number of fitting parameters;
qᵢ represents an i-th small-angle scattering vector;
Iₑₓₚ represents a scattering intensity of grazing-incidence small-angle scattering in an experiment;
ΔI(·) represents a small-angle scattering intensity error in the experiment;
I_{all-sphere-Monte}( ) represents the model scattering intensity.
And Θ^{(t)} represents a parameter value of a tth iteration, and Θ₁=Θ⁽⁰⁾.

Parameter update module configured to update Θ^{(t)} to Θ^{(t+1)}, where

$${Θ}^{( t + 1 )} = {Θ}^{( t )} - η {∇}_{Θ} ℒ ( {Θ}^{( t )} ) .$$

Termination check and result output module configured to re-calculate a loss function [symbol] ^{(t+1)} of a t+1-th iteration and compare the loss function [symbol] ^{(t+1)} with a loss function [symbol] ^{t} of the t-th iteration, if | [symbol] ^{(t+1)}- [symbol] ^{(t)}|<0.01 or the maximum number of iterations Tₘₐₓ is reached, terminate the iteration and trigger the verification fitting quality module; and if | [symbol] ^{(t+1)}- [symbol] ^{(t)}|≥0.01 and the maximum number of iterations Tₘₐₓ is not reached, trigger the calculation gradient module and the parameter update module to continue the iteration.

Verification fitting quality module configured to output a fitting parameter result Θ*, where Θ*=Θ^{(t)}, set a gradient descent optimal solution θ₂=Θ*, judge whether

$${X}_{r}^{2} ( {θ}_{2} ) < 1 , if {X}_{r}^{2} ( {θ}_{2} ) < 1 ,$$

determine that a fitting quality is qualified and retain Θ*, and if

$${X}_{r}^{2} ( {θ}_{2} ) \geq 1 ,$$

determine that the fitting quality is not qualified and discard Θ*.

In some embodiments, Module M6 includes:
Module M6.1 configured to perform statistical processing on the fitting parameter result, output a final fitting result Θₒᵤₜ±Δθₒᵤₜ, and compare and evaluate a physical meaning of the fitting parameter and a reasonableness thereof under experimental conditions in combination with other characterization methods;
and Module M6.2 configured to output as a one-dimensional table and a two-dimensional table according to a match between fitting data obtained from the final fitting result and the experimental data to obtain the visualization fitting result.

Compared with the prior art, the present disclosure has the following beneficial effects:
1. The present disclosure, by introducing a multi-stage optimization process, realizes fully automated processing from data pre-processing and model construction to parameter fitting, solving a problem of characterization deviation where a traditional data processing process relies on manual operation, results are significantly affected by subjective factors and model selection, and stability is poor.
2. The present disclosure, by combining Monte Carlo optimization and fine adjustment links, realizes efficient processing of grazing-incidence small-angle scattering data, precise fitting of model parameters, and quantitative characterization of material microstructures, significantly improving fitting accuracy, requiring short time for a fitting process, and meeting needs for efficient processing of multiple sets of experimental data.
3. The present disclosure, by adopting a multi-level optimization algorithm combining Monte Carlo optimization and gradient descent, solves a problem of loss of microstructure characterization information caused by insufficient adaptability of a data fitting model, and significantly improves processing efficiency of GISAS experimental data and quantitative characterization capability of microstructures, providing more reliable technical support for subsequent material research.

### BRIEF DESCRIPTION OF THE DRAWINGS

Other features, objects, and advantages of the present disclosure will become more apparent by reading the detailed description made to non-limiting embodiments with reference to the following drawings:

FIG. 1 is a flow schematic of grazing-incidence small-angle scattering fitting;

FIG. 2 is a schematic diagram of geometry of grazing-incidence small-angle scattering;

FIG. 3 is a schematic diagram of experimental raw data of an RPV high-energy iron ion 300° C. irradiation sample;

FIG. 4 is a schematic diagram of experimental one-dimensional data of the RPV high-energy iron ion 300° C. irradiation sample;

FIG. 5 is a schematic diagram of an experimental fitting result of the RPV high-energy iron ion 300° C. irradiation sample;

FIG. 6 is a schematic diagram of experimental raw data of an RPV low-energy iron ion 200° C. irradiation sample;

FIG. 7 is a schematic diagram of experimental one-dimensional data of the RPV low-energy iron ion 200° C. irradiation sample;

FIG. 8 is a schematic diagram of an experimental fitting result of the RPV low-energy iron ion 200° C. irradiation sample;

FIG. 9 is a schematic diagram of experimental raw data of an RPV medium-energy proton room temperature irradiation sample;

FIG. 10 is a schematic diagram of experimental one-dimensional data of the RPV medium-energy proton room temperature irradiation sample; and

FIG. 11 is a schematic diagram of an experimental fitting result of the RPV medium-energy proton room temperature irradiation sample.

### DETAILED DESCRIPTION

The present disclosure will be described in detail below in conjunction with specific embodiments. The following embodiments will help those skilled in the art to further understand the present disclosure, but do not limit the present disclosure in any form. It should be noted that for those of ordinary skill in the art, several changes and improvements can be made without departing from the concept of the present disclosure. These all belong to the protection scope of the present disclosure.

Based on automated processing and fitting technology, the present disclosure solves deficiencies caused by human intervention and model limitations in a traditional method in GISAS experimental data processing, and implements fully automated processing from data pre-processing and model construction to parameter fitting by introducing a multi-stage optimization process.

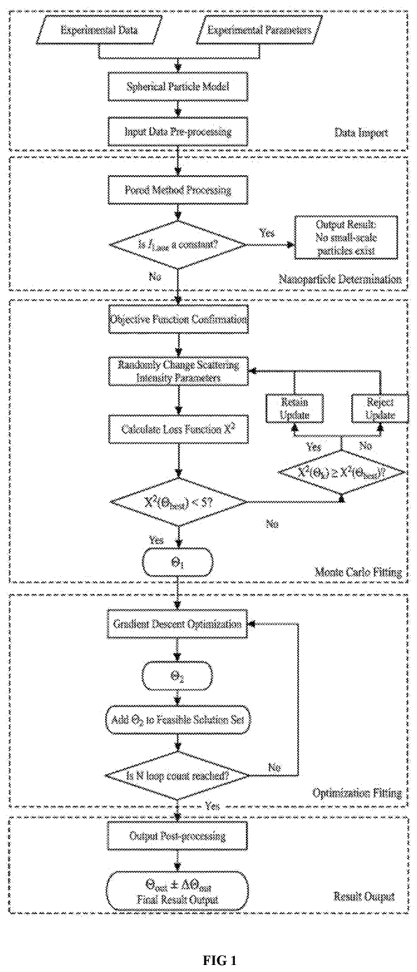

Provided according to the present disclosure is a grazing-incidence small-angle scattering data fitting method. Taking FIG. 1 as an example, starting from normalization and filtering of experimental data, multi-dimensional fitting optimization is performed on a material microstructure, and high accuracy and repeatability of a final result are ensured by combining advanced optimization algorithms (such as Monte Carlo fitting and gradient descent) and error analysis methods. Specifically, the method includes the following steps:

Step S1: establishing a grazing-incidence small-angle scattering model (Model Selection).

Step S1.1: determining a material model (such as a spherical model) of small-angle scattering experimental data and a distribution function of a structure parameter thereof; and constructing a fitting function and setting a parameter to be fitted.

A grazing-incidence small-angle scattering (GISAS) buried model is selected, where a structure factor not only depends on a scattering vector, but also depends on an incident vector and an exit vector. Each term is weighted by a corresponding Fresnel reflection coefficient and refraction coefficient. These coefficients are defined in a reflection stage or a refraction stage, respectively, thereby obtaining a shape factor of a corrected grazing-incidence small-angle scattering buried model.

A spherical particle is one of the most common precipitate forms, widely existing in various material systems, such as a metal alloy, a polymer, and a nanocomposite. Formation of such particles is usually closely related to a heat treatment or phase transition process of a material, and size, distribution, and morphology characteristics thereof have a significant impact on a microstructure and a macroscopic property of the material.

The spherical particle usually has a certain embedding depth and rotation angle on a surface layer. For the spherical particle, the rotation angle does not affect vector distribution because the spherical particle is assumed to be isotropic, obtaining a rotation matrix combined with a scattering vector under burial. In order to simplify the model to a certain extent and match real experimental results (most spherical particles appearing in samples such as RPV do not have the embedding depth), it is assumed that the embedding depth/R=2, from which a calculation formula for single-particle spherical grazing-incidence small-angle scattering intensity can be further derived.

In a spherical particle model setting link, first, it is necessary to confirm whether a position where a nanoparticle exists is embedded in a substrate according to a geometric structure of an actual sample to be measured. If yes, the buried model needs to be selected; otherwise, a supported model needs to be selected.

Second, in a precipitate nanoparticle of a metal alloy sample, a size often follows a log-normal distribution. Here, it can be assumed that any structural parameter K follows the log-normal distribution, and a distribution density function thereof is N_{log}. Then there is a corresponding parameter (R, σ) such that:

$${N}_{log} ( K , m , ϵ ) = \frac{1}{K ϵ \sqrt{2 π}} {e}^{- \frac{{( ln ( K - m ) )}^{2}}{2 {ϵ}^{2}}}$$

Correspondingly setting a fitting parameter and an expression for intensity thereof in spherical particle grazing-incidence small-angle scattering:

$${I}_{all - sphere} ( R , σ , q , {k}_{i} , {k}_{f} , {a}_{i} , {a}_{f} , {θ}_{f} , {f}_{v} ) = {\sum }_{{θ}_{f} = {θ}_{0}}^{{θ}_{f} = {θ}_{max}} {\sum }_{{a}_{f} = 0 °}^{{a}_{f} = {a}_{f}} {\sum }_{R = R - σ}^{R = R + σ} {I}_{single - sphere} ( R , σ , q , {k}_{i} , {k}_{f} , {a}_{i} , {a}_{f} , {θ}_{f} , {f}_{v} )$$

In summary, in a model setting link, parameters (q, kᵢ, k_{f}, aᵢ, a_{f}, θ_{f}) are intermediate terms in a simulation fitting process, and have no influence on significance of an overall fitting experiment.

Two types of parameters to be fitted are selected: a first type is a parameter required to be fitted for a log-normal distribution model, which is (m, ϵ); and a second type is a parameter required to be fitted for a spherical particle scattering intensity, which is (R, σ, fᵥ).
m represents a mean of a radius of the spherical particle;
ϵ represents a mean variance of the radius of the spherical particle;
R represents a single spherical particle radius;
σ represents a mean variance of the single spherical particle radius;
fᵥ represents a spherical particle volume fraction coefficient;
K represents a structure parameter;
θ_{f} represents an in-plane exit angle;
θ₀ represents a minimum in-plane exit angle;
θₘₐₓ represents a maximum in-plane exit angle;
I_{single-sphere} represents a grazing-incidence small-angle scattering illumination intensity of the single spherical particle radius;
kᵢ represents an incident wave vector;
k_{f} represents an exit wave vector;
aᵢ represents an incident angle;
a_{f} represents an exit angle; and
q represents a small-angle scattering vector.

A larger parameter range is selected and given according to an objective law. For example, a range of the nanoparticle is 0.1 nm-100 nm.

Step S1.2: constructing a parameter search space according to an experimental data input range (such as qₘᵢₙ, qₘₐₓ).

Step S2: an experimental data pre-processing link (Input Pre-processing).

Step S2.1: performing normalization on experimental data to ensure balance of data in error weight and distribution.

Step S2.2: setting an upper limit and a lower limit of a search space according to an experimental data range and a resolution.

Step S3: determining whether nanoparticles/small-scale structures exist by using a Porod fitting method.

Specifically, the Porod method is used to determine whether a small-scale nanoparticle structure exists in the sample. In the Porod method, a small-angle scattering intensity can be expressed by a specific formula as:

$${I}_{porod} = \frac{{c}_{p}}{{q}^{n}} + {I}_{Laue}$$

where Cₚ is called a Porod constant, I_{Laue} represents a Laue scattering intensity, and a value of n is between 3 and 4, reflecting a geometric characteristic of a scattering surface. When n is close to 4, it can be considered that a surface of the sample is relatively smooth, while a smaller n represents a rough surface or diverse morphology. I_{Laue} represents the Laue scattering intensity.

In grazing-incidence small-angle scattering data fitting, the surface is relatively smooth, so I_{porod}q⁴=Cₚ+I_{Laue}q⁴ is adopted.

A curve with q⁴ as a horizontal axis and I_{porod}q⁴ as a vertical axis is plotted. In a range of qR<<1, if a scattering curve presents a significant linear relationship, it indicates that I_{Laue} is a constant in this region, and the linear relationship corresponds to dominance of a sample surface or interfacial characteristic, rather than a contribution of a granular structure to scattering. Through the above determination method, especially in research of processing an irradiation sample, existence of a small nano-precipitate particle in the sample can be effectively distinguished. Not only can a structural characteristic of the sample be quickly determined, but dependence on a complex fitting process can also be significantly reduced, improving efficiency of data analysis. Therefore, this method is used as a primary determination step after VGISAS data pre-processing, so as to optimize a subsequent fitting process after confirming existence of a small-scale structure.

Step S4: Monte Carlo fitting (Coarse Tuning).

This process aims to confirm whether a global optimal solution inferred by a Monte Carlo method is true and reliable. This strategy can ensure that a subsequent optimization process focuses on a most promising region in a parameter space, effectively exploring the parameter space, while improving accuracy of a fitting result through higher-precision local optimization, providing a high-quality initial parameter for subsequent gradient descent optimization, thereby improving optimization accuracy and efficiency.

The Monte Carlo method divides the parameter space into high-dimensional grids, and calculates a scattering intensity I_{all-sphere-Monte} (m, ϵ, R, σ, fᵥ) by randomly generating a combined parameter Θₖ={m, ϵ, R, σ, fᵥ}. After each sampling, performance of a parameter combination thereof in a loss function is evaluated, and a chi-square value

$$( {X}_{r}^{2} )$$

thereof is calculated, where

$${X}_{r}^{2} = {\frac{1}{N - n} [ \frac{{I}_{exp} ( {q}_{i} ) - {I}_{all - sphere - Monte} ( {Θ}_{k} )}{Δ I ( {q}_{i} )} ]}^{2} ;$$

where N represents a number of grazing-incidence small-angle scattering experimental points;
n represents a number of fitting parameters;
q_i represents an i-th small-angle scattering vector;
Iₑₓₚ represents a scattering intensity of grazing-incidence small-angle scattering in an experiment;
ΔI(·) represents a small-angle scattering intensity error in the experiment; and
I_{all-sphere-Monte}(·) represents a model scattering intensity.

Specifically, the following steps are included:
an initial parameter setting step: setting a parameter range Θₘᵢₙ≤Θₖ≤Θₘₐₓ in the parameter space, and reasonably defining the range through empirical data or prior knowledge;
a random sampling step: generating a parameter set Θₖ using random distribution, where generated parameters are used to calculate a model scattering intensity I_{all-sphere-Monte}(Θₖ);
a loss function calculation step: calculating a corresponding loss function value

$${x}_{r}^{2}$$

according to each group of random parameters; comparing the corresponding loss function value with an optimal value; and determining

$${X}_{r}^{2} ( {Θ}_{k} ) ,$$

where if

$${X}_{r}^{2} ( {Θ}_{k} ) < {X}_{r}^{2} ( {Θ}_{b e s t} ) ,$$

letting Θ_{best}=Θₖ, and if

$${X}_{r}^{2} ( {Θ}_{k} ) \geq {X}_{r}^{2} ( {Θ}_{b e s t} ) ,$$

executing the random sampling step;
a fitting termination step: determining

$${X}_{r}^{2} ( {Θ}_{b e s t} )$$

and a number of samplings, where if

$${X}_{r}^{2} ( {Θ}_{b e s t} ) < 5$$

or a set upper limit of the number of samplings is reached, terminating fitting, and if

$${X}_{r}^{2} ( {Θ}_{b e s t} ) \geq 5$$

and the set upper limit is not reached, continuing fitting; and
a result output step: outputting a best parameter Θ_{best}, and letting Θ₁=Θ_{best} be passed into a gradient descent optimization algorithm as a starting point.

Compared with traditional methods, automatic search and fitting of model parameters are realized through Monte Carlo fitting and the gradient descent algorithm, avoiding errors caused by manual adjustment. At the same time, multiple sets of GISAS data can be efficiently processed, and results under different experimental conditions can be integrated, significantly improving analysis efficiency.

Step S5: iteratively updating the parameter by using a gradient descent method (Gradient Method) to gradually approach the global optimal solution.

A gradient descent optimization method is a classic iterative optimization algorithm. A core idea thereof is to gradually adjust parameters by calculating gradient information of an objective function (such as a loss function or a chi-square statistic), so as to make the parameters approach an optimal solution in a direction where the objective function descends fastest. In a VGISAS fitting algorithm, the gradient descent method realizes efficient local optimization by utilizing the gradient information, which is an important supplementary means after global search by the Monte Carlo method.

In the gradient descent method, assuming that the objective function is a loss function [symbol] (θ₁), where θ₁=Θ_{best} is an optimal solution after Monte Carlo fitting, representing a set of fitting parameters, then gradient descent adjusts the parameters by updating the following formula:

$${Θ}^{( t + 1 )} = {Θ}^{( t )} - η {∇}_{Θ} ℒ ( {Θ}^{( t )} )$$

where Θ^{(t)} represents a parameter value of a t-th iteration, η>0 is a learning rate controlling a step size of each update, and ∇_{Θ} [symbol] (Θ^{(t)}) is a gradient of the loss function with respect to the parameter, representing a variation trend of a current parameter on an objective function value. Therefore, in VGISAS fitting, a gradient of the objective function chi-square statistic

$${x}_{r}^{2}$$

can be expressed as:

$${∇}_{Θ} {X}_{r}^{2} = - \frac{2}{N - n} {\sum }_{i = 1}^{N} \frac{{I}_{exp} ( {q}_{i} ) - {I}_{all - sphere - Monte} ( Θ )}{Δ I ( {q}_{i} )} \cdot \frac{\partial {I}_{all - sphere - Monte} ( Θ )}{\partial Θ}$$

Specific application steps of the gradient optimization algorithm in VGISAS are as follows:
an initialization parameter step: setting an initial learning rate η and a maximum number of iterations Tₘₐₓ according to an initial parameter set Θ_{best} provided by the Monte Carlo method; calculating an initial loss function

$${ℒ}^{( 0 )} = {X}_{r}^{2} ( {Θ}_{1} ) ;$$

and recording an initial gradient as ∇_{Θ} [symbol] (Θ^{(t)});
a calculation gradient step: calculating a gradient ∇_{Θ} [symbol] (Θ^{(t)}) for the loss function [symbol] (Θ) under a current parameter;
a parameter update step: updating Θ^{(t)} to Θ^{(t+1)};
a termination check and result output step: re-calculating a loss function [symbol] ^{(t+1)} and comparing after each iteration, where if | [symbol] ^{(t+1)}- [symbol] ^{(t)}|<0.01 or the maximum number of iterations Tₘₐₓ is reached, terminating iteration and outputting a result; and if | [symbol] ^{(t+1)}- [symbol] ^{(t)}|≥0.01 and the maximum number of iterations Tₘₐₓ is not reached, continuing iteration; and
a verify fitting quality step: outputting a fitting parameter set Θ* after optimization is completed; and letting θ₂=Θ* as a gradient descent optimal solution to determine whether

$${X}_{r}^{2} ( {θ}_{2} ) < 1$$

holds to evaluate fitting quality. If

$${X}_{r}^{2} ( {θ}_{2} ) < 1 ,$$

determining that the fitting quality is qualified and retaining a fitting result, and if

$${X}_{r}^{2} ( {θ}_{2} ) \geq 1 ,$$

determining that the fitting quality is not qualified and discarding the fitting result.

An advantage of the gradient optimization algorithm lies in precise fitting, which can control an error within a very small range. A disadvantage lies in that calculation for a complex function is easy to fall into a local optimum. Based on a global initial parameter provided by the Monte Carlo method, the gradient descent optimization algorithm is further used to finely fit a result. By combining the Monte Carlo fitting and a gradient descent optimization optimal result, advantages of the gradient descent and the Monte Carlo method are fully utilized, and reliability and consistency of each fitting parameter are comprehensively evaluated.

Specifically, the Monte Carlo method is used for global search to provide the initial parameter, while the gradient descent performs fine adjustment on this basis. A final fitting parameter value is selected through a chi-square distribution test, and an optimization result report containing fitting accuracy, error distribution, and a parameter confidence interval is generated, realizing effective combination of global and local optimization. Finally, an optimized parameter result θₒᵤₜ is output for subsequent experimental analysis and result verification. This hybrid strategy ensures efficiency and accuracy of fitting, providing a reliable solution for grazing-incidence small-angle scattering data analysis of a complex system.
Step S6: a data post-processing link (Post-process).
Step S6.1: performing statistical processing on a fitting parameter result; outputting a final fitting result θₒᵤₜ±Δθₒᵤₜ; and evaluating a physical meaning of a fitting parameter and reasonableness thereof under an experimental condition.

Main content of evaluation is to evaluate whether the fitting parameter matches actual information of the sample, comparing in combination with other characterization methods.

| Sample ID | Test Method | m₁ | σ₁ |
|---|---|---|---|
| RPV-HE-300T- | GISAXS | 1.69 nm | 0.87 nm |
| 1 · 0 dpa | SANS | 1.55 nm | 0.30 nm |
| | APT | 1.34 nm | 0.28 nm |

In the table, m₁ represents a mean of a radius of a spherical particle of sample ID RPV-HE-300T-1.0dpa, and σ₁ represents a mean variance of a radius of a single spherical particle of sample ID RPV-HE-300T-1.0dpa.

These differences are reasonable because: APT mainly collects surface atoms of a tip sample, and a “truncation effect” may exist during a collection process, that is, only a part of a particle is measured, resulting in a slightly smaller measured particle size; a measurement result of SANS is slightly larger than that of APT, reflecting relatively objective characterization thereof on an overall particle size of the sample; and a particle size measured by GISAXS is the largest, which is because a grazing incidence mode is more sensitive to a nanostructure on a surface and a near-surface region of the sample, and under a condition of high-energy particle irradiation, an irradiation effect is often concentrated on the surface or the near-surface region of the material, leading to accelerated atomic migration and rearrangement in a surface region, thereby forming a larger precipitate.

Step S6.2: providing a confidence interval of a fitting result and an optimization report, including confidence space estimation for each fitting parameter, and quantitative analysis of overall performance of a fitting model. At the same time, a chi-square test X² and a mean squared error test (MSE) are introduced to quantitatively evaluate precision and consistency of the fitting result, determining whether the model conforms to experimental data in a statistical sense.

Step S6.3: visualizing the fitting result, intuitively presenting a match situation between fitting data and the experimental data through a one-dimensional table and a two-dimensional table, and performing distribution analysis on a fitting residual through an image to enhance intuitive understanding of fitting quality.

Since there is no need to rely on additional model selection, complete information in an original two-dimensional scattering image can be retained, accurately characterizing anisotropy and complex arrangement characteristics of a microstructure.

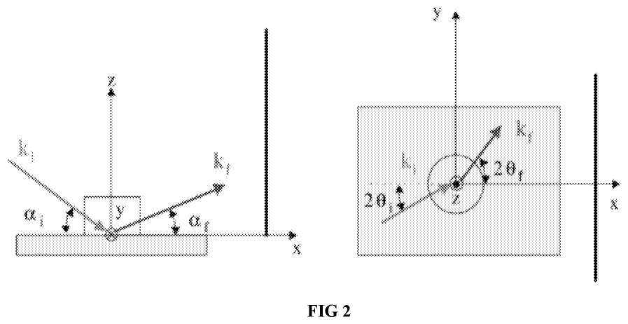

In more examples, experimental fitting is performed on samples in a sample list. Under set conditions, all samples have undergone action of specific irradiation energy and temperature, leading to formation of a precipitate in an internal microstructure, specifically manifested as morphology of a spherical particle. Such a precipitate is a common damage product of various steel alloy materials in a nuclear irradiation environment. Size distribution, density, and a phase structure characteristic thereof are accurately captured by grazing-incidence small-angle scattering (GISAXS) technology taking FIG. 2 as an example.

TABLE 1
Experimental Sample List

| | | | Irradiation | |
|---|---|---|---|---|
| Irradiation | Ion | Irradiation | Damage | |
| Ion Species | Energy | Temperature | Amount | Remark |
| Iron ion | 352.8 | 300° C. | 1.0 dpa | RPV steel, 352.8 |
| | MeV | | | MeV Fe ion |
| | | | | 300° C. |
| | | | | irradiation, front |
| | | | | and back surfaces |
| | | | | 50 micron |
| | | | | uniform damage |
| | Low- | 200° C. | 1.0 dpa | RPV steel, low- |
| | energy | | | energy iron ion |
| | | | | room temperature |
| | | | | irradiation 1.0 dpa |
| Proton | Medium- | Room | 0.35 dpa | RPV, medium- |
| | energy | temperature | | energy proton |
| | | | | irradiation 0.35 |
| | | | | dpa |

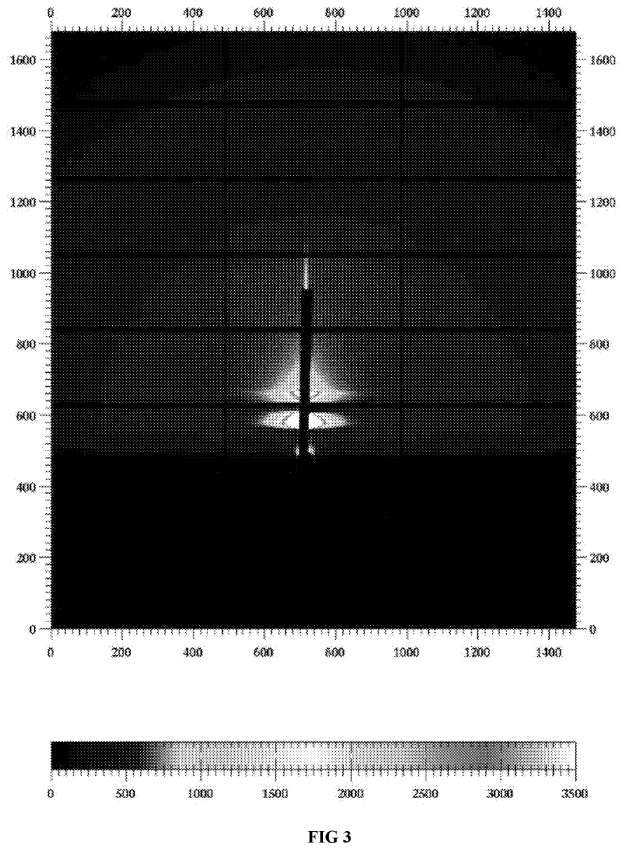

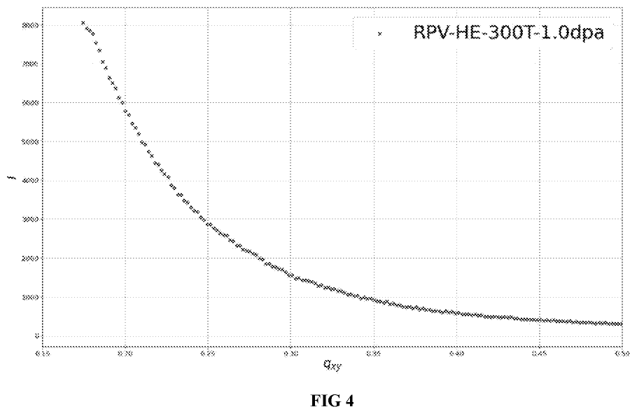

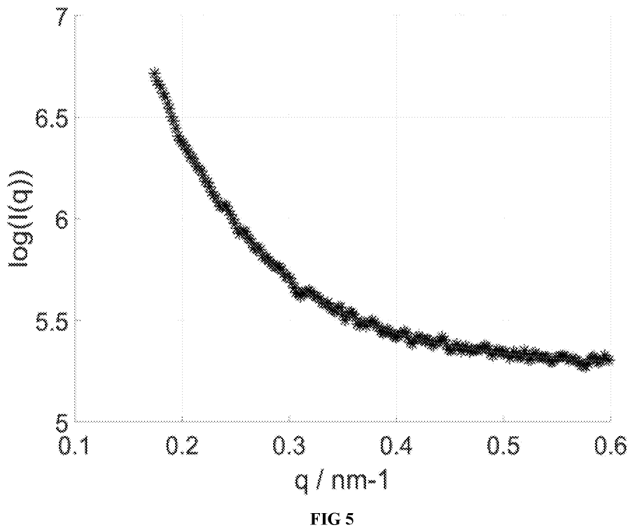

Processing and analysis of experimental data are performed on the sample. For RPV steel high-energy iron ion at an irradiation intensity of 300° C., an irradiation damage amount of 1.0 dpa is adopted, with uniform damage of 50 μm on front and back surfaces. Grazing-incidence small-angle scattering experimental raw data is shown in FIG. 3, experimental one-dimensional data is shown in FIG. 4, and a fitting result is shown in FIG. 5. I is an abbreviation for intensity, and q_{xy} represents the irradiation damage amount.

TABLE 2
Fitting result of RPV high-energy iron ion 300° C. irradiation sample

| Data Name | Rm1 | sigma1 | fV1 | C | alpha | lbg | Chi2 | CorMap |
|---|---|---|---|---|---|---|---|---|
| VSAS-RPV1p0_{—} | 1.688999 | 0.86994 | 1.82228 | 1.78E−06 | 2.3904 | 103.3047 | 60.91391 | 35.12183 |
| qy.txt | | | | | | | | |
| | MaxPatch | PValue | Fit_Times | Total_Time | Mean_Time | Form_Type | Dis_Mode | Dis_Mode |
| | 35 | 1.32E−09 | 3 | 110.31 | 36.77 | Sphere | Single | LogNormal |

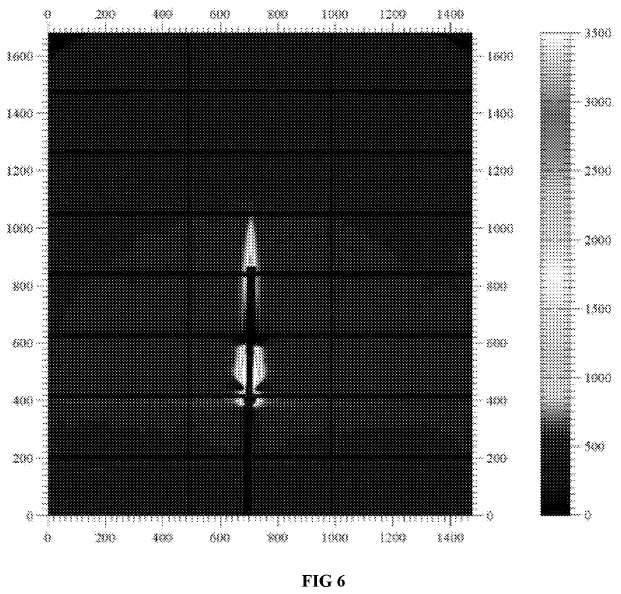

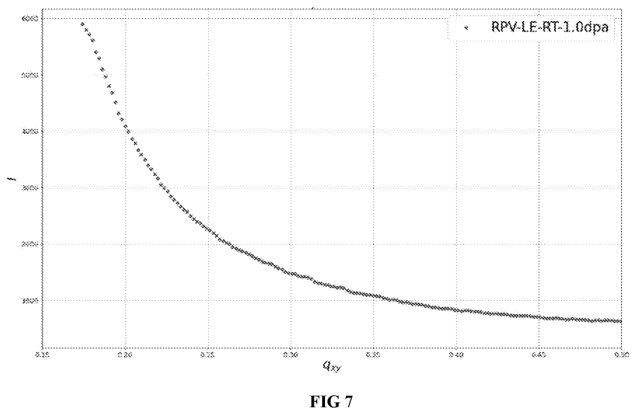

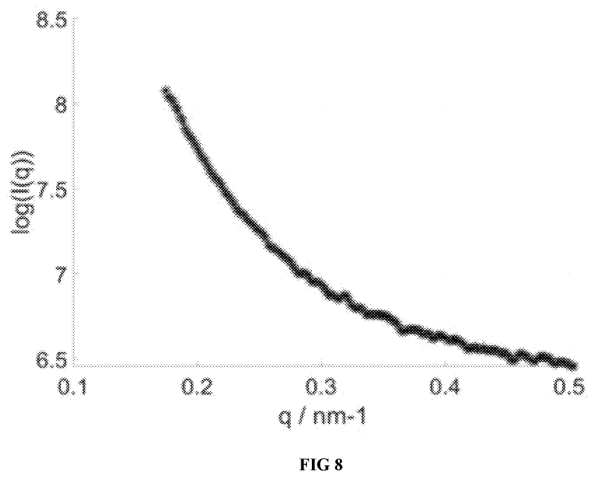

In more examples, for RPV steel low-energy iron ion at an irradiation intensity of 200° C., damage with an irradiation damage amount of 1.0 dpa is adopted. Grazing-incidence small-angle scattering experimental raw data is shown in FIG. 6, experimental one-dimensional data is shown in FIG. 7, and a fitting result is shown in FIG. 8.

TABLE 3
Fitting result of RPV low-energy iron ion 200° C. irradiation sample

| Data Name | Rm1 | sigma1 | fV1 | C | alpha | lbg | Chi2 | CorMap |
|---|---|---|---|---|---|---|---|---|
| VSAS-RPV1p0_{—} | 1.986373 | 0.58508 | 0.4953 | 3.54236 | 3.9998 | 423.4402 | 4.300097 | 31.50045 |
| qy.txt | | | | | | | | |
| | MaxPatch | PValue | Fit_Times | Total_Time | Mean_Time | Form_Type | Dis_Mode | Dis_Type |
| | 31 | 1.58E−08 | 3 | 112.93 | 37.64 | Sphere | Single | LogNormal |

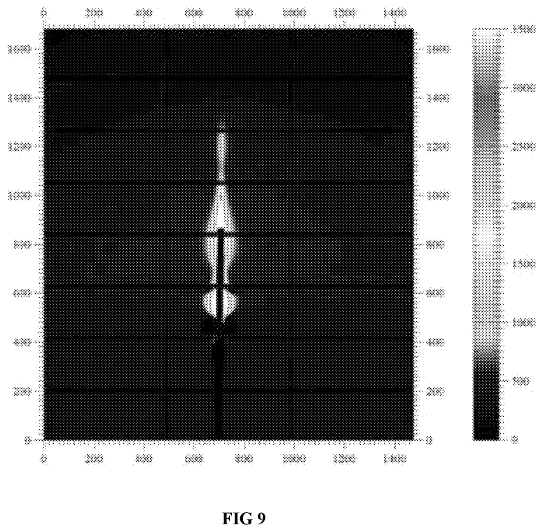

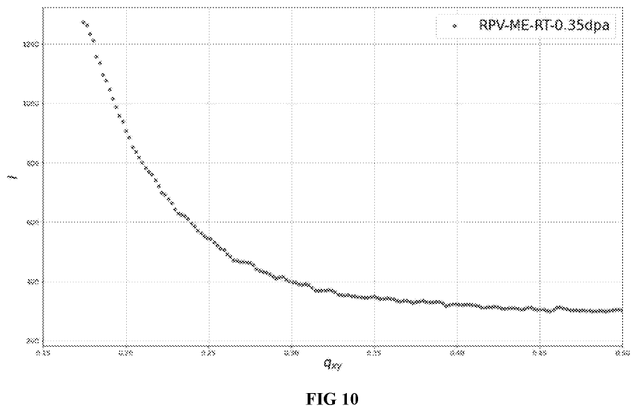

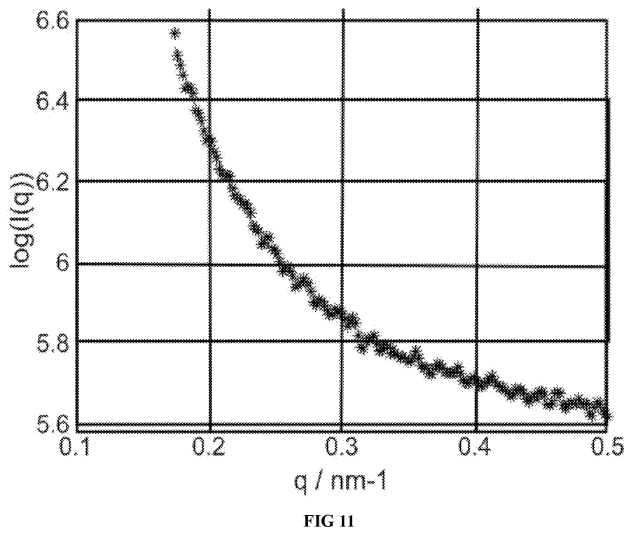

In more examples, for RPV medium-energy proton at an irradiation intensity of room temperature, damage with an irradiation damage amount of 0.35 dpa is adopted. Grazing-incidence small-angle scattering experimental raw data is shown in FIG. 9, experimental one-dimensional data is shown in FIG. 10, and a fitting result is shown in FIG. 11.

TABLE 4
Fitting result of RPV medium-energy proton room temperature irradiation sample

| Data Name | Rm1 | sigma1 | fV1 | C | alpha | lbg | Chi2 | CorMap |
|---|---|---|---|---|---|---|---|---|
| VSAS-RPV1p0_{—} | 1.654207 | 0.99999 | 0.0497 | 1.07365 | 3.9999 | 350.8389 | 0.594458 | 28.36061 |
| qy.txt | | | | | | | | |
| | MaxPatch | PValue | Fit_Times | Total_Time | Mean_Time | Form_Type | Dis_Mode | Dis_Type |
| | 28 | 1.29E−07 | 3 | 87.6 | 29.2 | Sphere | Single | LogNormal |

The present disclosure further provides a grazing-incidence small-angle scattering data fitting system. The grazing-incidence small-angle scattering data fitting system can be implemented by executing process steps of the grazing-incidence small-angle scattering data fitting method. That is, those skilled in the art can understand the grazing-incidence small-angle scattering data fitting method as an example of the grazing-incidence small-angle scattering data fitting system.

Provided according to the present disclosure is a grazing-incidence small-angle scattering data fitting system, including:
Module M1: configured to construct a grazing-incidence small-angle scattering model to obtain an objective function;
Module M2: configured to pre-process experimental data and input the experimental data into the objective function;
Module M3: configured to determine a spherical particle by using a Porod fitting method according to the experimental data after pre-processing;
Module M4: configured to confirm the objective function according to a determination result, perform Monte Carlo fitting, and output a best parameter;
Module M5: configured to iteratively optimize the best parameter by using a gradient descent method, and output a fitting parameter result; and
Module M6: configured to perform post-processing on the fitting parameter result, and output a visualization fitting result and perform evaluation.

In more examples, Module M1 includes:

Module M1.1: configured to select a buried model or a supported model according to a geometric structure of an actual sample to be measured; and set a distribution density function of a spherical particle model

$${N}_{log} ( K , m , ϵ ) = \frac{1}{K ϵ \sqrt{2 π}} {e}^{- \frac{{( ln ( K - m ) )}^{2}}{2 {ϵ}^{2}}}$$

and a scattering intensity of a spherical particle grazing-incidence small-angle scattering model

$${I}_{all - sphere} ( R , σ , q , {k}_{i} , {k}_{f} , {a}_{i} , {a}_{f} , {θ}_{f} , {f}_{v} ) = {\sum }_{{θ}_{f} = {θ}_{0}}^{{θ}_{f} - {θ}_{max}} {\sum }_{{a}_{f} = 0 °}^{{a}_{f} = {a}_{f}} {\sum }_{R = R - σ}^{R = R + σ} {I}_{single - sphere} ( R , σ , q , {k}_{i} , {k}_{f} , {a}_{i} , {a}_{f} , {θ}_{f} , {f}_{v} ) ,$$

where
m represents a mean of a radius of the spherical particle;
ϵ represents a mean variance of the radius of the spherical particle;
R represents a single spherical particle radius;
σ represents a mean variance of the single spherical particle radius;
fᵥ represents a spherical particle volume fraction coefficient;
K represents a structure parameter;
θ_{f} represents an in-plane exit angle;
θ₀ represents a minimum in-plane exit angle;
θₘₐₓ represents a maximum in-plane exit angle;
I_{single-sphere}( ) represents a grazing-incidence small-angle scattering illumination intensity of the single spherical particle radius;
kᵢ represents an incident wave vector;
k_{f} represents an exit wave vector;
aᵢ represents an incident angle;
a_{f} represents an exit angle; and
q represents a small-angle scattering vector.

Module M1.2: configured to input a parameter range to be fitted qₘᵢₙ and qₘₐₓ according to an objective law to construct a parameter space for parameter search.

Module M2 includes:
Module M2.1: configured to perform normalization on the experimental data;
and Module M2.2: configured to set an upper limit and a lower limit of the parameter space according to the parameter range to be fitted and a resolution that is set.

Module M3 includes:
Module M3.1: configured to calculate a small-angle scattering intensity I_{porod}, where I_{porod}q⁴=Cₚ+I_{Laue}q⁴
where Cₚ represents a Porod constant; and
I_{Laue} represents a Laue scattering intensity.

Module M3.2: configured to plot a curve with q⁴ as a horizontal axis and I_{porod}q⁴ as a vertical axis; and determine a relationship of a scattering curve in a range of qR<<1, where if the scattering curve presents a significant linear relationship, indicating that I_{Laue} is a constant at this time, determining that no spherical particle exists and ending fitting, and if the scattering curve does not present the significant linear relationship, determining that the spherical particle exists and continuing to trigger Module M4.

In more examples, Module M4 includes:
an initial parameter setting module: configured to set a parameter range Θₘᵢₙ≤Θₖ<Θₘₐₓ in the parameter space of the objective function through empirical data or prior knowledge;
where Θₖ represents a combined parameter; and
Θₘᵢₙ and Θₘₐₓ represent a minimum value and a maximum value of the combined parameter, respectively;
a random sampling module: configured to input a randomly distributed generation parameter set Θₖ into the objective function to obtain a model scattering intensity I_{all-sphere-Monte}(Θₖ)
a loss function calculation module: configured to set a chi-square value of an initial best parameter

$${X}_{r}^{2} ( {Θ}_{best} ) > 5 ;$$

calculate a corresponding loss function chi-square value

$${X}_{r}^{2} ( {Θ}_{k} ) = {\frac{1}{N - n} [ \frac{{I}_{exp} ( {q}_{i} ) - {I}_{all - sphere - Monte} ( {Θ}_{k} )}{Δ I ( {q}_{i} )} ]}^{2}$$

according to the parameter set Θₖ; and determine

$${X}_{r}^{2} ( {Θ}_{k} ) ,$$

where if

$${X}_{r}^{2} ( {Θ}_{k} ) < {X}_{r}^{2} ( {Θ}_{best} ) ,$$

letting Θ_{best}=Θₖ, and if

$${X}_{r}^{2} ( {Θ}_{k} ) \geq {X}_{r}^{2} ( {Θ}_{best} ) ,$$

triggering the random sampling module;
where N represents a number of grazing-incidence small-angle scattering experimental points;
n represents a number of fitting parameters;
q_i represents an i-th small-angle scattering vector;
Iₑₓₚ represents a scattering intensity of grazing-incidence small-angle scattering in an experiment;
ΔI(·) represents a small-angle scattering intensity error in the experiment; and
I_{all-sphere-Monte}(·) represents a model scattering intensity.
a fitting termination module: configured to determine

$${X}_{r}^{2} ( {Θ}_{best} )$$

and a number of samplings, where if

$${X}_{r}^{2} ( {Θ}_{best} ) < 5$$

or a set upper limit of the number of samplings is reached, triggering a result output module, and if

$${X}_{r}^{2} ( {Θ}_{best} ) \geq 5$$

and the set upper limit is not reached, triggering the random sampling module and the loss function calculation module to continue fitting; and
the result output module: configured to output the best parameter Θ_{best}, and let a starting point Θ₁=Θ_{best} be passed into a gradient descent optimization algorithm.

In more examples, Module M5 includes:
an initialization parameter module: configured to set an initial learning rate η and a maximum number of iterations Tₘₐₓ according to the starting point Θ₁ obtained by the best parameter Θ_{best}, where Θ₁=Θ_{best} and η>0, calculate an initial loss function

$${ℒ}^{( 0 )} = {X}_{r}^{2} ( {Θ}_{1} ) ;$$

and record an initial gradient as ∇_{Θ} [symbol] (Θ₁);
a calculation gradient module: configured to calculate a gradient of a loss function with respect to a parameter ∇_{Θ} [symbol] (Θ^{(t)}) for the loss function [symbol] (Θ^{(t)}) under a Θ^{(t)} parameter, where

$${∇}_{Θ} ℒ ( {Θ}^{( t )} ) = - \frac{2}{N - n} {\sum }_{i = 1}^{N} \frac{{I}_{exp} ( {q}_{i} ) - {I}_{all - sphere - Monte} ( {Θ}^{( t )} )}{Δ I ( {q}_{i} )} \cdot \frac{\partial {I}_{all - sphere - Monte} ( {Θ}^{( t )} )}{\partial {Θ}^{( t )}} ;$$

where N represents a number of grazing-incidence small-angle scattering experimental points;
n represents a number of fitting parameters;
qᵢ represents an i-th small-angle scattering vector;
Iₑₓₚ represents a scattering intensity of grazing-incidence small-angle scattering in an experiment;
ΔI(·) represents a small-angle scattering intensity error in the experiment; and
I_{all-sphere-Monte}(·) represents a model scattering intensity. and
Θ^{(t)} represents a parameter value of a t-th iteration, and Θ₁=Θ⁽⁰⁾;
a parameter update module: configured to update Θ^{(t)} to Θ^{(t+1)}, where Θ^{(t+1)}=Θ^{(t)}−η∇_{Θ} [symbol] (Θ^{(t)}); and
a termination check and result output module: configured to re-calculate a loss function of a t+1-th iteration [symbol] ^{(t+1)} and compare [symbol] ^{(t+1)} with a loss function of the t-th iteration [symbol] ^{t}, where if | [symbol] ^{(t+1)}- [symbol] ^{(t)}|<0.01 or the maximum number of iterations Tₘₐₓ is reached, terminate iteration and trigger a verify fitting quality module, and if |L^{(t+1)}- [symbol] ^{(t)}|≥0.01 and the maximum number of iterations Tₘₐₓ is not reached, trigger the calculation gradient module and the parameter update module to continue iteration.
the verify fitting quality module: configured to output the fitting parameter result Θ*, where Θ*=Θ^{(t)}; let a gradient descent optimal solution θ₂=Θ*; and determine

$${X}_{r}^{2} ( {θ}_{2} ) < 1 ,$$

where if

$${X}_{r}^{2} ( {θ}_{2} ) < 1 ,$$

determining that fitting quality is qualified and retaining Θ*, and if

$${X}_{r}^{2} ( {θ}_{2} ) < 1 ,$$

determining that the fitting quality is not qualified and discarding Θ*.

In more examples, Module M6 includes:
Module M6.1: configured to perform statistical processing on the fitting parameter result; output a final fitting result θₒᵤₜ±Δθₒᵤₜ; and compare and evaluate a physical meaning of a fitting parameter and reasonableness thereof under an experimental condition in combination with another characterization method; and
Module M6.2: configured to output a one-dimensional table and a two-dimensional table according to a match situation between fitting data obtained by the final fitting result and the experimental data to obtain the visualization fitting result.

Those skilled in the art know that, in addition to implementing the system and various devices, modules, and units thereof provided by the present disclosure in a form of purely computer-readable program codes, the system and the various devices, modules, and units thereof provided by the present disclosure can be completely realized in forms of a logic gate, a switch, an application-specific integrated circuit, a programmable logic controller, and an embedded microcontroller by performing logic programming on method steps to realize a same function. Therefore, the system and the various devices, modules, and units thereof provided by the present disclosure can be considered as a hardware component, and devices, modules, and units included therein for realizing various functions can also be regarded as a structure within the hardware component; or the devices, modules, and units for realizing various functions can be regarded as both a software module for implementing a method and the structure within the hardware component.

Specific embodiments of the present disclosure have been described above. It should be understood that the present disclosure is not limited to the above specific embodiments, and those skilled in the art can make various changes or modifications within the scope of the claims, which does not affect the substance of the present disclosure. In a case of no conflict, embodiments of the present application and features in the embodiments can be arbitrarily combined with each other.

1. A grazing-incidence small-angle scattering data fitting method, comprising:
Step S1: constructing a grazing-incidence small-angle scattering model to obtain an objective function;
Step S2: pre-processing experimental data and inputting the experimental data into the objective function;
Step S3: determining a spherical particle by using a Porod fitting method according to the experimental data after pre-processing;
Step S4: confirming the objective function according to a determination result, performing Monte Carlo fitting, and outputting a best parameter;
Step S5: iteratively optimizing the best parameter by using a gradient descent method, and outputting a fitting parameter result; and
Step S6: performing post-processing on the fitting parameter result, outputting a visualization fitting result, and performing evaluation;
wherein Step S4 comprises:
an initial parameter setting step: setting a parameter range Θₘᵢₙ≤Θₖ≤Θₘₐₓ in a parameter space of the objective function through empirical data or prior knowledge;
where Θₖ represents a combined parameter; and Θₘᵢₙ and Θₘₐₓ represent a minimum value and a maximum value of the combined parameter, respectively;
a random sampling step: inputting a randomly distributed generation parameter set Θₖ into the objective function to obtain a model scattering intensity I_{all-sphere-Monte}(Θₖ)
a loss function calculation step: setting a chi-square value of an initial best parameter
$${X}_{r}^{2} ( {Θ}_{best} ) > 5 ;$$
calculating a corresponding loss function chi-square value
$${X}_{r}^{2} ( {Θ}_{k} ) = {\frac{1}{N - n} [ \frac{{I}_{exp} ( {q}_{i} ) - {I}_{all - sphere - Monte} ( {Θ}_{k} )}{Δ I ( {q}_{i} )} ]}^{2}$$
according to the parameter set
$${X}_{r}^{2} ( {Θ}_{k} ) ;$$
and determining
$${X}_{r}^{2} ( {Θ}_{k} ) ,$$
wherein if
$${X}_{r}^{2} ( {Θ}_{k} ) < {X}_{r}^{2} ( {Θ}_{best} ) ,$$
letting Θ_{best}=Θₖ and if
$${X}_{r}^{2} ( {Θ}_{k} ) \geq {X}_{r}^{2} ( {Θ}_{best} ) ,$$
executing the random sampling step;
where N represents a number of grazing-incidence small-angle scattering experimental points;
n represents a number of fitting parameters;
qᵢ represents an i-th small-angle scattering vector;
Iₑₓₚ represents a scattering intensity of grazing-incidence small-angle scattering in an experiment;
ΔI(·) represents a small-angle scattering intensity error in the experiment; and
I_{all-sphere-Monte}(·) represents a model scattering intensity;
a fitting termination step: determining
$${X}_{r}^{2} ( {Θ}_{best} )$$
and a number of samplings, wherein if
$${X}_{r}^{2} ( {Θ}_{best} ) < 5$$
or a set upper limit of the number of samplings is reached, executing a result output step, and if
$${X}_{r}^{2} ( {Θ}_{best} ) \geq 5$$
and the set upper limit is not reached, executing the random sampling step and the loss function calculation step to continue fitting; and
the result output step: outputting the best parameter Θ_{best}, and letting a starting point Θ₁=Θ_{best} be passed into a gradient descent optimization algorithm.

2. The grazing-incidence small-angle scattering data fitting method according to claim 1, wherein Step S1 comprises:
Step S1.1: selecting a buried model or a supported model according to a geometric structure of an actual sample to be measured; and setting a distribution density function of a spherical particle model
$${N}_{log} ( K , m , ϵ ) = \frac{1}{K ϵ \sqrt{2 π}} {e}^{- \frac{{( ln ( K - m ) )}^{2}}{2 {ϵ}^{2}}}$$
and a scattering intensity of a spherical particle grazing-incidence small-angle scattering model
$${I}_{all - sphere} ( R , σ , q , {k}_{i} , {k}_{f} , {a}_{i} , {a}_{f} , {θ}_{f} , {f}_{v} ) = {\sum }_{{θ}_{f} = {θ}_{0}}^{{θ}_{f} = {θ}_{max}} {\sum }_{{a}_{f} = 0 °}^{{a}_{f} = {a}_{f}} {\sum }_{R = R - σ}^{R = R + σ} {I}_{single - sphere} ( R , σ , q , {k}_{i} , {k}_{f} , {a}_{i} , {a}_{f} , {θ}_{f} , {f}_{v} )$$
collectively as the objective function; and constructing a fitting function and setting parameters to be fitted (m, ϵ) and (R, σ, fᵥ);
where
m represents a mean of a radius of the spherical particle;
Σ represents a mean variance of the radius of the spherical particle;
R represents a single spherical particle radius;
σ represents a mean variance of the single spherical particle radius;
fᵥ represents a spherical particle volume fraction coefficient;
K represents a structure parameter;
θ_{f} represents an in-plane exit angle;
θ₀ represents a minimum in-plane exit angle;
θₘₐₓ represents a maximum in-plane exit angle;
I_{single-sphere}( ) represents a grazing-incidence small-angle scattering illumination intensity of the single spherical particle radius;
kᵢ represents an incident wave vector;
k_{f} represents an exit wave vector;
aᵢ represents an incident angle;
a_{f} represents an exit angle; and
q represents a small-angle scattering vector.
Step S1.2: inputting a parameter range to be fitted qₘᵢₙ, qₘₐₓ according to an objective law to construct a parameter space for parameter search.
wherein Step S2 comprises:
Step S2.1: performing normalization on the experimental data; and
Step S2.2: setting an upper limit and a lower limit of the parameter space according to the parameter range to be fitted and a resolution that is set; and
wherein Step S3 comprises:
Step S3.1: calculating a small-angle scattering intensity I_{porod}, where I_{porod}q⁴=Cₚ+I_{Laue}q⁴;
where Cₚ represents a Porod constant; and
I_{Laue} represents a Laue scattering intensity; and
Step S3.2: plotting a curve with q⁴ as a horizontal axis and I_{porod}q⁴ as a vertical axis; and determining a relationship of a scattering curve in a range of qR<<1, wherein if the scattering curve presents a significant linear relationship, indicating that I_{Laue} is a constant at this time, determining that no spherical particle exists and ending fitting, and if the scattering curve does not present the significant linear relationship, determining that the spherical particle exists and continuing to execute Step S4.3. The submerged arc welding method for marine nickel alloy steel, wherein in step (1), the thickness of the splicing base material is 40 mm to 50 mm.

3. The grazing-incidence small-angle scattering data fitting method according to claim 1, wherein Step S5 comprises:
an initialization parameter step: setting an initial learning rate η and a maximum number of iterations Tₘₐₓ according to the starting point Θ₁ obtained by the best parameter Θ_{best}, where Θ₁=Θ_{best} and η>0; calculating an initial loss function
$${ℒ}^{( 0 )} = {X}_{r}^{2} ( {Θ}_{1} ) ;$$
and recording an initial gradient as ∇_{Θ} [symbol] (Θ₁);
a calculation gradient step: calculating a gradient of a loss function with respect to a parameter ∇_{Θ} [symbol] (Θ^{(t)})) for the loss function [symbol] (Θ^{(t)}) under a Θ^{(t)} parameter, where
$${∇}_{Θ} ℒ ( {Θ}^{( t )} ) = - \frac{2}{N - n} {\sum }_{i = 1}^{N} \frac{{I}_{exp} ( {q}_{i} ) - {I}_{all - sphere - Monte} ( {Θ}^{( t )} )}{Δ I ( {q}_{i} )} \cdot \frac{\partial {I}_{all - sphere - Monte} {Θ}^{( t )} )}{\partial {Θ}^{( t )}} ;$$
where N represents the number of grazing-incidence small-angle scattering experimental points;
n represents the number of fitting parameters;
qᵢ represents the i-th small-angle scattering vector;
Iₑₓₚ represents the scattering intensity of grazing-incidence small-angle scattering in the experiment;
ΔI(·) represents the small-angle scattering intensity error in the experiment;
I_{all-sphere-Monte}(·) represents the model scattering intensity;
and Θ^{(t)} represents a parameter value of a t-th iteration, and Θ₁=Θ⁽⁰⁾.
Parameter update step: updating Θ^{(t)} to Θ^{(t+1)} where Θ^{(t+1)}=Θ^{(t)}−η∇_{Θ} [symbol] (Θ^{(t)}).
Termination check and result output step: re-calculating a loss function [symbol] ^{(t+1)} of a (t+1)-th iteration and comparing the loss function [symbol] ^{(t+1)} with a loss function [symbol] ^{t} of the t-th iteration, if | [symbol] ^{(t+1)}- [symbol] ^{(t)}|<0.01 or the maximum number of iterations Tₘₐₓ is reached, terminating the iteration and executing the verifying fitting quality step; and if | [symbol] ^{(t+1)}- [symbol] ^{(t)}|≥0.01 and the maximum number of iterations Tₘₐₓ is not reached, executing the calculating gradient step and the parameter update step to continue the iteration.
Verifying fitting quality step: outputting a fitting parameter result Θ*, where Θ*=Θ^{(t)}, setting a gradient descent optimal solution θ₂=Θ*, judging whether
$${X}_{r}^{2} ( {θ}_{2} ) < 1 ,$$
determining that a fitting quality is qualified and retaining θ*, and if
$${X}_{r}^{2} ( {θ}_{2} ) \geq 1 ,$$
determining that the fitting quality is not qualified and discarding Θ*.

4. The grazing-incidence small-angle scattering data fitting method according to claim 1, wherein Step S6 comprises:
Step S6.1: performing statistical processing on the fitting parameter result; outputting a final fitting result θₒᵤₜ±Δθₒᵤₜ; and comparing and evaluating a physical meaning of a fitting parameter and reasonableness thereof under an experimental condition in combination with another characterization method; and
Step S6.2: outputting a one-dimensional table and a two-dimensional table according to a match situation between fitting data obtained by the final fitting result and the experimental data to obtain the visualization fitting result.

5. A grazing-incidence small-angle scattering data fitting system, comprising:
Module M1: configured to construct a grazing-incidence small-angle scattering model to obtain an objective function;
Module M2: configured to pre-process experimental data and input the experimental data into the objective function;
Module M3: configured to determine a spherical particle by using a Porod fitting method according to the experimental data after pre-processing;
Module M4: configured to confirm the objective function according to a determination result, perform Monte Carlo fitting, and output a best parameter;
Module M5: configured to iteratively optimize the best parameter by using a gradient descent method, and output a fitting parameter result; and
Module M6: configured to perform post-processing on the fitting parameter result, and output a visualization fitting result and perform evaluation;
wherein Module M4 comprises:
an initial parameter setting module: configured to set a parameter range Θₘᵢₙ≤Θₖ≤Θₘₐₓ in a parameter space of the objective function through empirical data or prior knowledge;
where Θₖ represents a combined parameter; and Θₘᵢₙ and Θₘₐₓ represent a minimum value and a maximum value of the combined parameter, respectively;
a random sampling module: configured to input a randomly distributed generation parameter set Θₖ into the objective function to obtain a model scattering intensity I_{all-sphere-Monte}(Θₖ);
a loss function calculation module: configured to set a chi-square value of an initial best parameter
$${X}_{r}^{2} ( {Θ}_{best} ) > 5 ;$$
calculate a corresponding loss function chi-square value
$${X}_{r}^{2} ( {Θ}_{k} ) = {\frac{1}{N - n} [ \frac{{I}_{exp} ( {q}_{i} ) - {I}_{all - sphere - Monte} ( {Θ}_{k} )}{Δ I ( {q}_{i} )} ]}^{2}$$
according to the parameter set Θₖ; and determine
$${X}_{r}^{2} ( {Θ}_{k} ) ,$$
wherein if
$${X}_{r}^{2} ( {Θ}_{k} ) < {X}_{r}^{2} ( {Θ}_{b e s t} ) ,$$
letting Θ_{best}=Θₖ, and if
$${X}_{r}^{2} ( {Θ}_{k} ) \geq {X}_{r}^{2} ( {Θ}_{b e s t} ) ,$$
triggering the random sampling module;
where N represents a number of grazing-incidence small-angle scattering experimental points;
n represents a number of fitting parameters;
qᵢ represents an i-th small-angle scattering vector;
Iₑₓₚ represents a scattering intensity of grazing-incidence small-angle scattering in an experiment;
ΔI(·) represents a small-angle scattering intensity error in the experiment; and
I_{all-sphere-Monte}(·) represents a model scattering intensity;
a fitting termination module: configured to determine
$${X}_{r}^{2} ( {Θ}_{b e s t} )$$
and a number of samplings, wherein if
$${X}_{r}^{2} ( {Θ}_{b e s t} ) < 5$$
or a set upper limit of the number of samplings is reached, triggering a result output module, and if
$${X}_{r}^{2} ( {Θ}_{b e s t} ) \geq 5$$
and the set upper limit is not reached, triggering the random sampling module and the loss function calculation module to continue fitting; and
the result output module: configured to output the best parameter Θ_{best}, and let a starting point Θ₁=Θ_{best} be passed into a gradient descent optimization algorithm.

6. The grazing-incidence small-angle scattering data fitting system according to claim 5, wherein Module M1 comprises:
Module M1.1: configured to select a buried model or a supported model according to a geometric structure of an actual sample to be measured; and set a distribution density function of a spherical particle model
$${N}_{log} ( K , m , ϵ ) = \frac{1}{K ϵ \sqrt{2 π}} e - \frac{{( ln ( K - m ) )}^{2}}{2 {ϵ}^{2}}$$
and a scattering intensity of a spherical particle grazing-incidence small-angle scattering model
$${I}_{all - sphere} ( R , σ , q , {k}_{i} , {k}_{f} , {a}_{i} , {a}_{f} , {θ}_{f} , {f}_{v} ) = {\sum }_{{θ}_{f} = {θ}_{0}}^{{θ}_{f} = {θ}_{max}} {\sum }_{{a}_{f} = 0 °}^{{a}_{f} = {a}_{f}} {\sum }_{R = R - σ}^{R = R + σ} {I}_{single - sphere} ( R , σ , q , {k}_{i} , {k}_{f} , {a}_{i} , {a}_{f} , {θ}_{f} , {f}_{v} )$$
collectively as the objective function; and construct a fitting function and set parameters to be fitted (m, ϵ) and (R, σ, fᵥ);
where
m represents a mean of a radius of the spherical particle;
ϵ represents a mean variance of the radius of the spherical particle;
R represents a single spherical particle radius;
σ represents a mean variance of the single spherical particle radius;
fᵥ represents a spherical particle volume fraction coefficient;
K represents a structure parameter;
θ_{f} represents an in-plane exit angle;
θ₀ represents a minimum in-plane exit angle;
θₘₐₓ represents a maximum in-plane exit angle;
I_{single-sphere}( ) represents a grazing-incidence small-angle scattering illumination intensity of the single spherical particle radius;
kᵢ represents an incident wave vector;
k_{f} represents an exit wave vector;
aᵢ represents an incident angle;
a_{f} represents an exit angle; and
q represents a small-angle scattering vector; and
Module M1.2: configured to input a parameter range to be fitted qₘᵢₙ and qₘₐₓ according to an objective law to construct a parameter space for parameter search;
wherein Module M2 comprises:
Module M2.1: configured to perform normalization on the experimental data; and
Module M2.2: configured to set an upper limit and a lower limit of the parameter space according to the parameter range to be fitted and a resolution that is set; and
wherein Module M3 comprises:
Module M3.1: configured to calculate a small-angle scattering intensity I_{porod}, where I_{porod}q p I_{Laue}q⁴;
where Cₚ represents a Porod constant; and
I_{Laue} represents a Laue scattering intensity; and
Module M3.2: configured to plot a curve with q⁴ as a horizontal axis and I_{porod}q⁴ as a vertical axis; and determine a relationship of a scattering curve in a range of qR<<1, wherein if the scattering curve presents a significant linear relationship, indicating that I_{Laue} is a constant at this time, determining that no spherical particle exists and ending fitting, and if the scattering curve does not present the significant linear relationship, determining that the spherical particle exists and continuing to trigger Module M4.

7. The grazing-incidence small-angle scattering data fitting system according to claim 5, wherein Module M5 comprises:
an initialization parameter module: configured to set an initial learning rate η and a maximum number of iterations Tₘₐₓ according to the starting point Θ₁ obtained by the best parameter Θ_{best}, where Θ₁=Θ_{best} and η>0, calculate an initial loss function
$${ℒ}^{( 0 )} = {X}_{r}^{2} ( {Θ}_{1} ) ;$$
and record an initial gradient as ∇_{Θ} [symbol] (Θ₁);
a calculation gradient module: configured to calculate a gradient of a loss function with respect to a parameter ∇_{Θ} [symbol] (Θ^{(t)}) for the loss function [symbol] (Θ^{(t)}) under a Θ^{(t)} parameter, where
$${∇}_{Θ} ℒ ( {θ}^{( t )} ) = - \frac{2}{N - n} {\sum }_{i = 1}^{N} \frac{{I}_{exp} ( {q}_{i} ) - {I}_{all - sphere - Monte} ( {Θ}^{( t )} )}{Δ I ( {q}_{i} )} .$$
$$\frac{\partial {I}_{all - sphere - Monte} ( {Θ}^{( t )} )}{\partial {Θ}^{( t )}} ;$$
where N represents a number of grazing-incidence small-angle scattering experimental points;
n represents a number of fitting parameters;
qᵢ represents an i-th small-angle scattering vector;
Iₑₓₚ represents a scattering intensity of grazing-incidence small-angle scattering in an experiment;
ΔI(·) represents a small-angle scattering intensity error in the experiment; and
I_{all-sphere-Monte}(·) represents a model scattering intensity. and
Θ^{(t)} represents a parameter value of a t-th iteration, and Θ₁=Θ⁽⁰⁾;
a parameter update module: configured to update Θ^{(t)} to Θ^{(t+1)}, where
$${Θ}^{( t + 1 )} = {Θ}^{( t )} - η {∇}_{Θ} ℒ ( {Θ}^{( t )} ) ;$$
a termination check and result output module: configured to re-calculate a loss function of a t+1-th iteration [symbol] ^{(t+1)} and compare [symbol] ^{(t+1)} with a loss function of the t-th iteration [symbol] ^{t}, where if | [symbol] ^{(t+1)}- [symbol] ^{(t)}|<0.01 or the maximum number of iterations Tₘₐₓ is reached, terminate iteration and trigger a verify fitting quality module, and if | [symbol] ^{(t+1)}- [symbol] ^{(t)}|≥0.01 and the maximum number of iterations Tₘₐₓ is not reached, trigger the calculation gradient module and the parameter update module to continue iteration; and
the verify fitting quality module: configured to output the fitting parameter result Θ*, where Θ*=Θ^{(t)}; let a gradient descent optimal solution θ₂=Θ*; and determine
$${X}_{r}^{2} ( {θ}_{2} ) < 1 ,$$
where if
$${X}_{r}^{2} ( {θ}_{2} ) < 1 ,$$
determining that fitting quality is qualified and retaining Θ*, and if
$${X}_{r}^{2} ( {θ}_{2} ) < 1 ,$$
determining that the fitting quality is not qualified and discarding Θ*.

8. The grazing-incidence small-angle scattering data fitting system according to claim 5, wherein Module M6 comprises:
Module M6.1: configured to perform statistical processing on the fitting parameter result; output a final fitting result θₒᵤₜ±Δθₒᵤₜ; and compare and evaluate a physical meaning of a fitting parameter and reasonableness thereof under an experimental condition in combination with another characterization method; and
Module M6.2: configured to output a one-dimensional table and a two-dimensional table according to a match situation between fitting data obtained by the final fitting result and the experimental data to obtain the visualization fitting result.
